(19) United States
(12) Patent Application Publication
(10) Pub. No.: US 2005/0161971 A1
(43) Pub. Date: Jul. 28, 2005

(54) Adjustable windshield for golf carts

(76) Inventor: Frederick George Wilson, Lisburn (GB)

Correspondence Address: FREDERICK G. WILSON, 49 HILLSBOROUGH OLD ROAD, LISBURN, BT27 5EW, GB

(21) Appl. No.: 10/763,721

(22) Filed: Jan. 26, 2004

(51) Int. Cl. B60J 1/02

(52) U.S. Cl. 296/79

(57) ABSTRACT

An adjustable windshield or windscreen for the front or rear openings on a golf cart. The windshield has an inner axle and outer roller with a tensionable spring affixed between the axles and outer roller. A curtain is attached to the outer roller with a fixed element sewn into a hem of the curtain. The curtain may be adjusted to various securing points and when released, automatically rewinds around the roller.

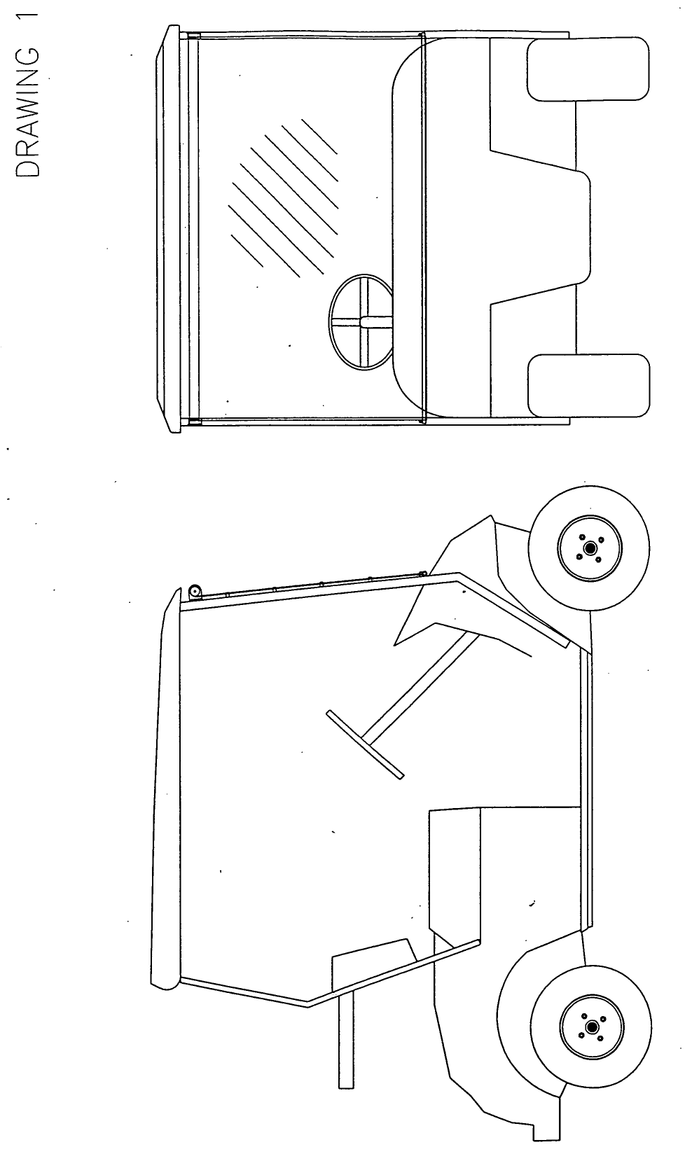

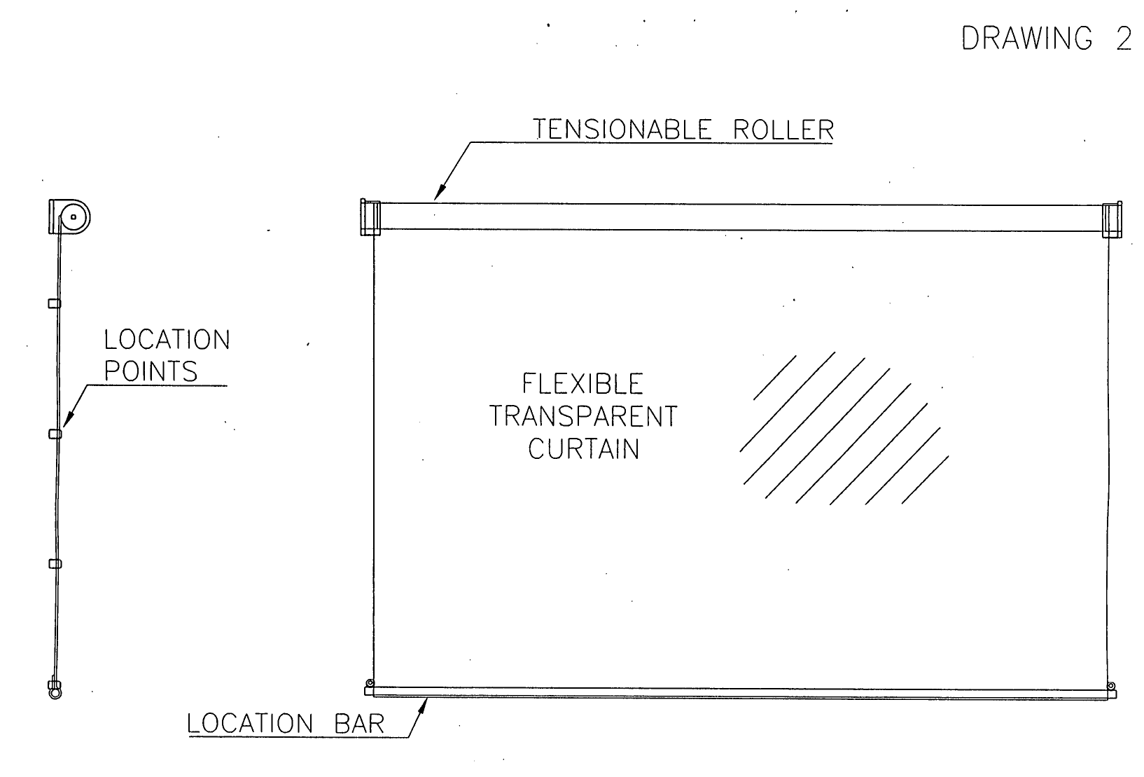

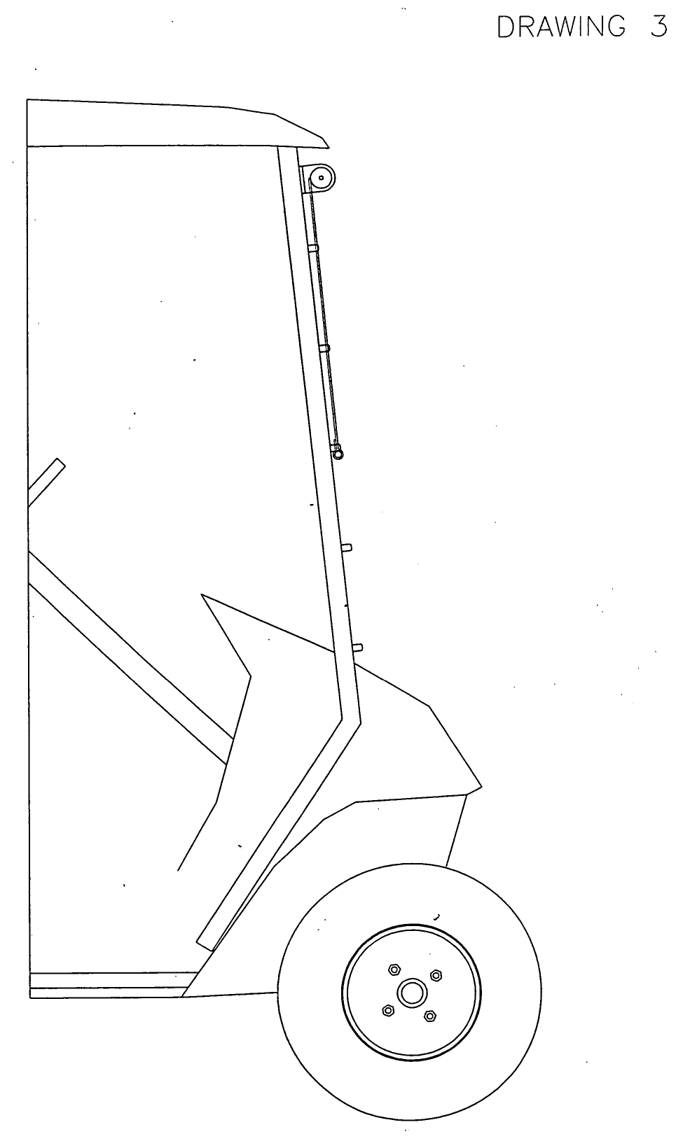

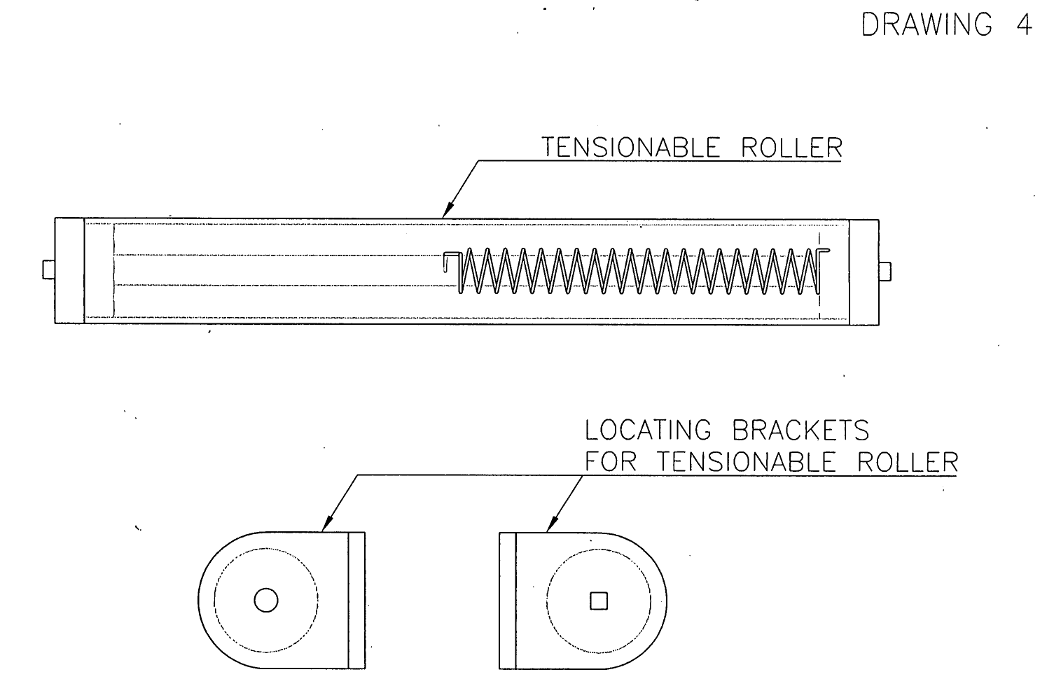

This invention relates exclusively to a windshield or windscreen for golf carts, which may be installed at the front or rear opening in a golf cart or at both openings.

A golf cart is a 4 wheeled vehicle used to carry 2 persons or more around a golf course as well as their golfing equipment.

The vehicles are extensively also used in industry and provide transport for hotel guests, hospital patients and many other purposes.

This invention relates exclusively to front and rear windshields for golf carts.

Golf carts generally leave the manufactures in a completely open configuration that is as a 4 wheeled vehicle with seats but without a roof, windshield or doors.

Many are shipped with a roof and windshield as an option

The aftermarket provides weather protection enclosures made of fabric or vinyl and a rigid sliding doors total enclosure is also available.

The conventional windshield generally consists of a one piece rigid transparent acrylic sheet. To provide ventilation in hot weather the windshield may consist of a 2 piece rigid structure with one section hinged and which can be opened when desired.

When the weather is hot, it is also known to provide a windshield made from light flexible transparent plastic material, which can be manually rolled up or down to cover the aperture at the front of the cart between the roof and cart bodywork.

This present invention relates to a flexible, retractable transparent curtain, which can be readily opened or closed or partially opened or closed to protect the passengers from wind or sudden rain.

The main components of the invention are a spring tensionable roller and a sheet of flexible transparent material.

The roller may consist of an inner axle and an outer axle.

A spirally wound spring may be located around the centre axle.

The outer tube has fixed end caps to support the centre axle. The centre axle protrudes beyond the ends of outer tube and is used to retain the complete roller in position.

The spiral spring is attached at one end to the centre axle and at the other end to the outer tube. The centre axle rotates freely in outer tube. The axle may be in one or two sections.

Instead of a spiral spring around the axle a clockwork type spring may be used with one end of the clockwork spring fixed to the centre axle and the other end of the spring to the outer tube.

Means are provided in the centre axle so that when it is fitted in its mounted position a square or rectangular protrusion at one end of the axle is located to fit within a matching square or rectangular hole in the mounting bracket prevent the central axle rotating.

The transparent curtain is fixedly attached rigidly to the surface of the outer tube and the curtain can be rolled around the tube.

At the opposite edge of the curtain from where it is attached to the circular tube, a rigid cross piece material may be sewn in to a hem formed in the curtain.

With the curtain rolled around the tube and the centre axle retained, the tube may be rotated to tension the spirally wound or clockwork spring.

If the cart is fitted with a roof there will normally be uprights from the body of the cart to support the roof.

By way of description of the operation of the curtain or windshield.

The tensionable roller is fitted to the uprights of the cart with the centre axle retained to prevent rotation. The curtain may be fitted at the top or bottom of the opening provided by the uprights from the cart body.

The outer tube is suitably tensioned and a cross piece rigid material is fitted within a hem of the curtain.

Projections on the uprights can be used to keep the windshield at the chosen position, either fully or partially unrolled.

Resting the rigid material will retain the tensioned curtain at the desired position. Releasing the rigid material from the projections, the curtain will automatically rewind around the tube. The windshield can be opened or closed from inside the cart.

Alternatively a rope or similar may be attached to both ends of the rigid cross piece. Each side of the rope may be passed over a pulley at the top or bottom of the opening. The end of each rope may be a ring or similar affixed to it.

By pulling the rings where the operator is inside the cart and attach to a projection, the windshield can be opened or closed to a predetermined position from inside the cart.

Because the uprights at the front of the cart are generally straight, adhesive rubber or similar may be attached to the front of the uprights to contour the uprights and help tension and stop the windshield vibrating in the wind.

Drawing 1 Illustration of golf cart showing windshield position.

Drawing 2 Illustration of adjustable windshield and adjustment points.

Drawing 3 Illustration of adjustable windshield at front of golf cart.

Drawing 4 Illustration of tensionable roller

1. What I claim as my inventions is an adjustable automatic rewinding, transparent windshield for a golf cart, adjustable from inside or outside the golf cart.
